(19) United States
(12) Patent Application Publication
(10) Pub. No.: US 2009/0070172 A1
(43) Pub. Date: Mar. 12, 2009

(54) RENT MANAGEMENT SOFTWARE

(76) Inventor: SIMON T. SCHLESINGER, Spring Valley, NY (US)

Correspondence Address: MICHAEL RIES, 318 PARKER PLACE, OSWEGO, IL, 60543, US

(21) Appl. No.: 12/207,950

(22) Filed: Sep. 10, 2008

Related U.S. Application Data
(60) Provisional application No. 60/971,260, filed on Sep. 10, 2007.

(51) Int. Cl. G06Q 10/00; G06F 7/10; G06F 3/048; G06Q 50/00; G06F 17/30

(52) U.S. Cl. 705/7; 707/4; 715/810; 704/8; 705/30; 707/E17.045; 707/E17.016

(57) ABSTRACT

Disclosed is software to manage tenants and provide accounting. The present invention is rent management software that allows unlimited tracking of properties and units. Provided is a powerful search engine that will scan a database in many different ways. An email or letter can be generated from any address stored in the database. A reminder feature will keep a user constantly organized with daily prompts. A find replace filter system is included to quickly save time and then money. An accounting system is included that requires little accounting experience.

This application claims priority to U.S. Provisional Application 60/971,260 filed 10-SEP-2007, the entire disclosure of which is incorporated by reference.

### TECHNICAL FIELD AND BACKGROUND

The present invention relates to management software. More specifically, the present invention provides software to manage tenants and provide accounting.

The present invention is rent management software that allows unlimited tracking of properties and units. Provided is a powerful search engine that will scan a database in many different ways. An email or letter can be generated from any address stored in the database. A reminder feature will keep a user constantly organized with daily prompts. A find/replace filter system is included to quickly save time and then money. An accounting system is included that requires little accounting experience. The present invention includes the option to use the software for any other type of business that requires tracking of income and expense activity, as well as the accounting aspect of any type of business including all financial reporting.

### BRIEF DESCRIPTION OF THE DRAWINGS

The objects, features, and advantages of the present invention will be apparent from the following detailed description of the preferred embodiment of the invention with references to the following drawings.

FIG. 1 is a screen shot of one embodiment of the present invention.

FIG. 2 is a screen shot of one embodiment of the present invention.

FIG. 3 is a screen shot of one embodiment of the present invention.

FIG. 4 is a screen shot of one embodiment of the present invention.

FIG. 5 is a screen shot of one embodiment of the present invention.

FIG. 6 is a screen shot of one embodiment of the present invention.

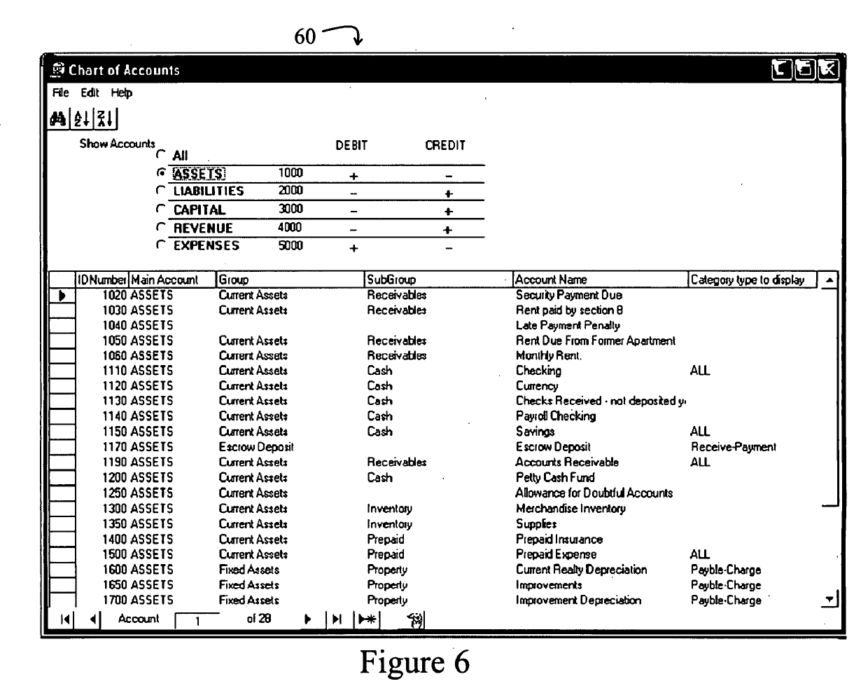

FIG. 7 is a screen shot of one embodiment of the present invention.

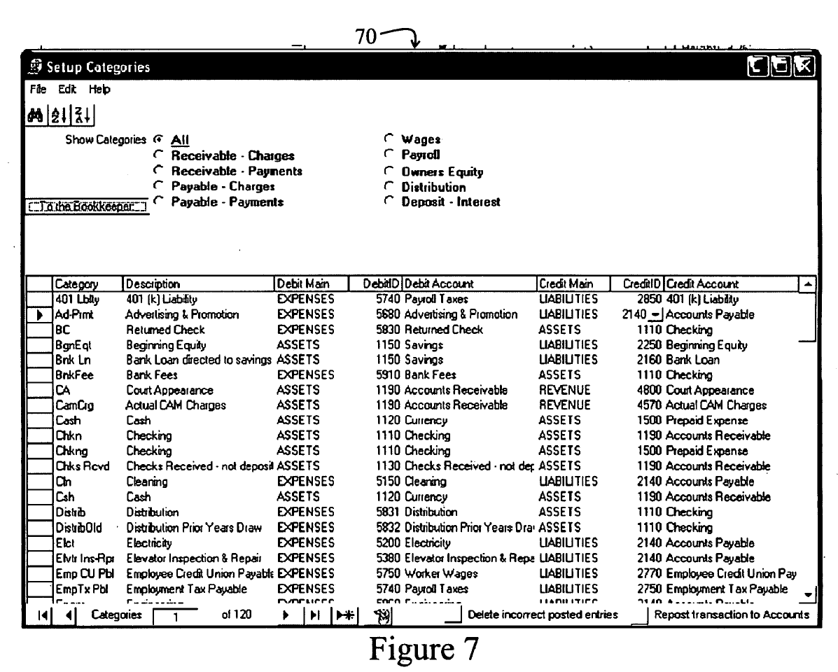

FIG. 8 is a screen shot of one embodiment of the present invention.

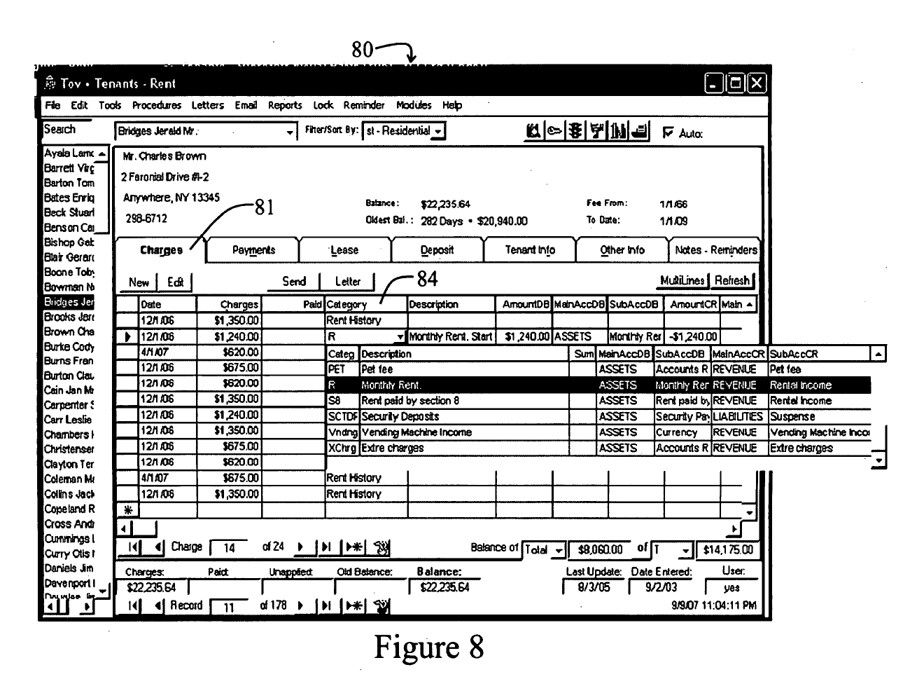

FIG. 9 is a screen shot of one embodiment of the present invention.

FIG. 10 is a screen shot of one embodiment of the present invention.

FIG. 11 is a screen shot of one embodiment of the present invention.

FIG. 12 is a screen shot of one embodiment of the present invention.

FIG. 13 is a screen shot of one embodiment of the present invention.

FIG. 14 is a screen shot of one embodiment of the present invention.

FIG. 15 is a screen shot of one embodiment of the present invention.

FIG. 16 is a screen shot of one embodiment of the present invention.

FIG. 17 is a screen shot of one embodiment of the present invention.

FIG. 18 is a screen shot of one embodiment of the present invention.

FIG. 19 is a screen shot of one embodiment of the present invention.

FIG. 20 is a screen shot of one embodiment of the present invention.

FIG. 21 is a screen shot of one embodiment of the present invention.

FIG. 22 is a screen shot of one embodiment of the present invention.

FIG. 23 is a screen shot of one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

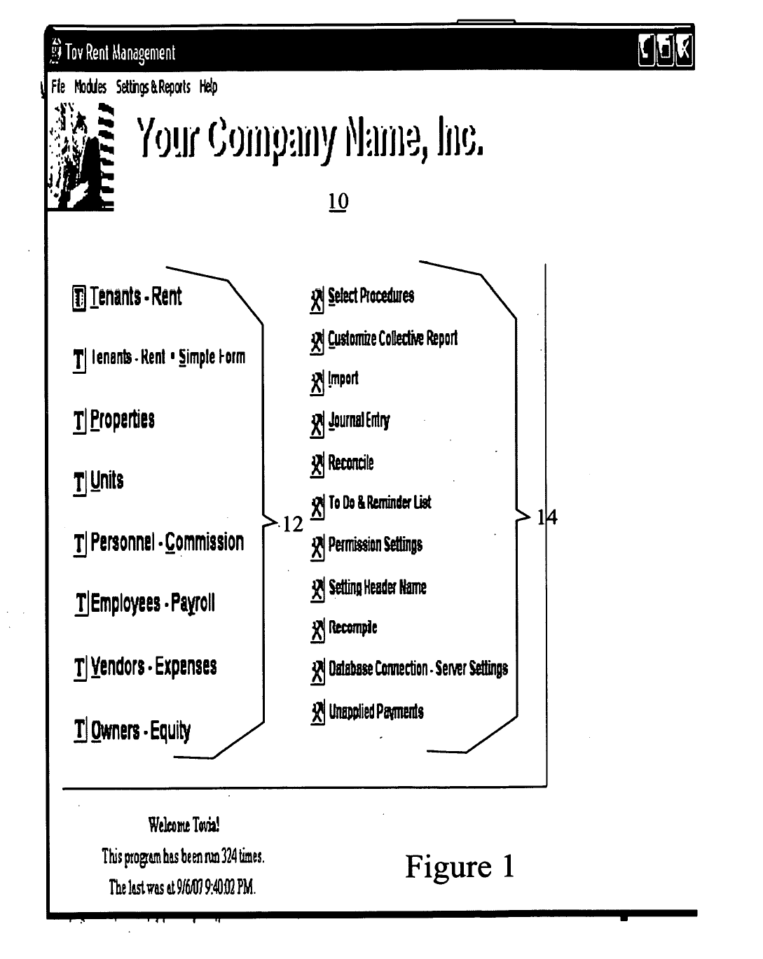

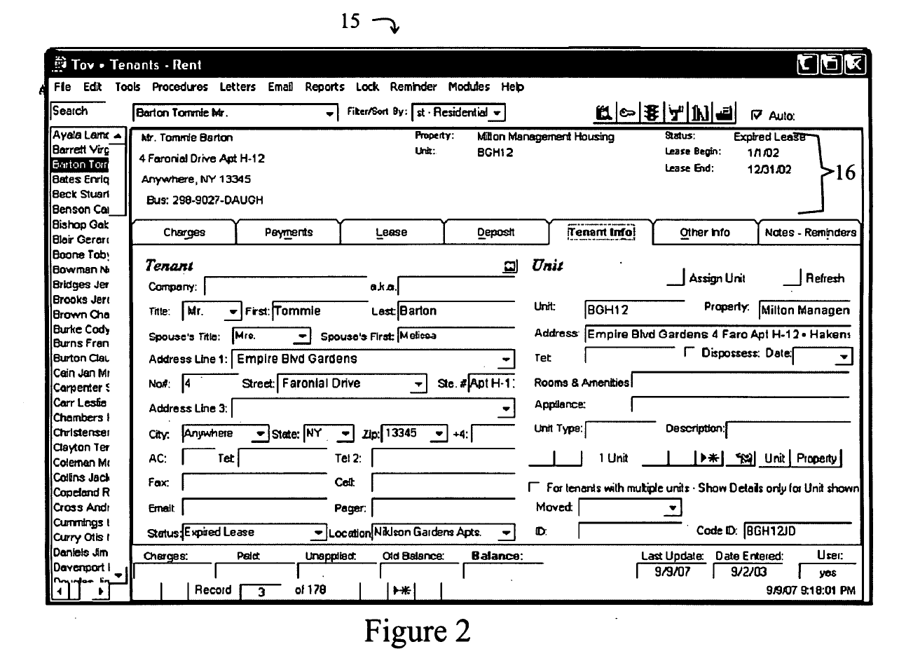

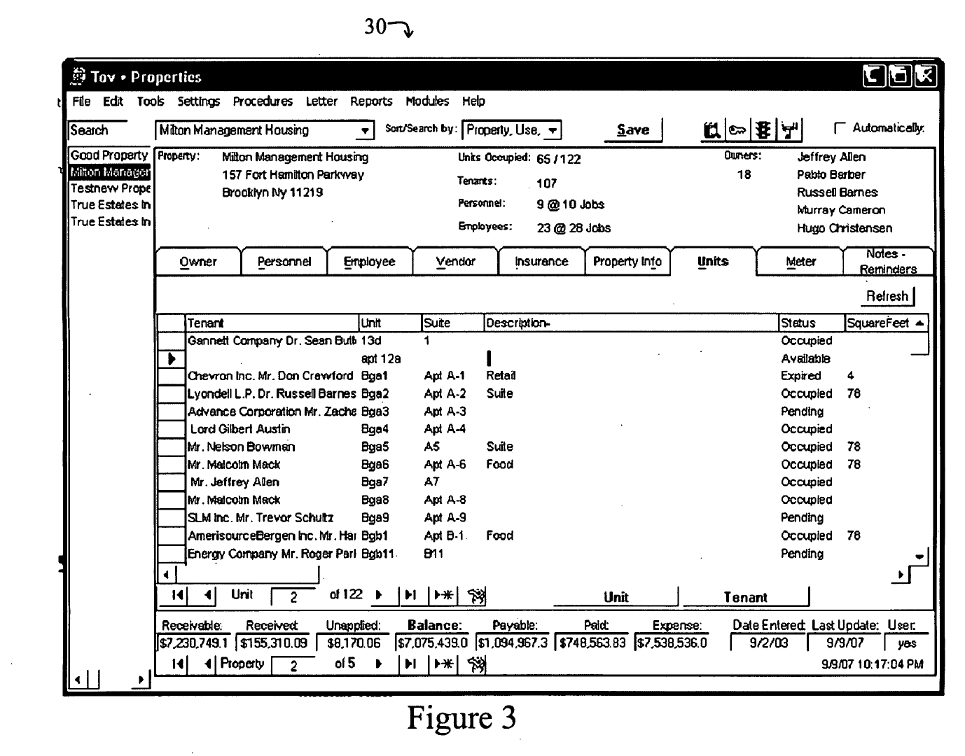

Referring to FIG. 1, as in one embodiment is a view of a main screen 10 with list of projects or modules 12 and a list of sections 14. Included may be seven individual projects that may be tenants rent, tenants rent simple form, properties, units, personnel-commission, employees-payroll, vendors-expenses, owners=equity. The seven individual projects are fully integrated into one relational database 13. In FIG. 2 as in one embodiment is a tenants rent window 15 with a data display window 16 that allows a user to click on the unit or property name in the data display window 16 to open the selected tenant's record in the respective modules. The present invention is designed in a way that every project, and section is so well integrated one with the other, that it provides a user-friendly environment, allowing the user to bring up information quickly and easily. In FIG. 3 as in one embodiment is a properties window 30 with a displayed list of records showing line items with tenant name, unit, suite, description, status and square foot. Entire lists of records can be displayed in every section of the program. If the user is currently in the Property section of the program, the data display window 16 shows him the totals of all the information related to this property. For example, “Units Occupied” will display the total number of units occupied related to the total number of units in the property. In the lower part of the screen, in the Units tab, a list of all the tenants occupying units in this property, are displayed. One can click on any tenant's name and open the Tenant's account in the Tenant's module, displaying the tenant's pertinent information. There is no need to exit the section you currently are in, to enter another section.

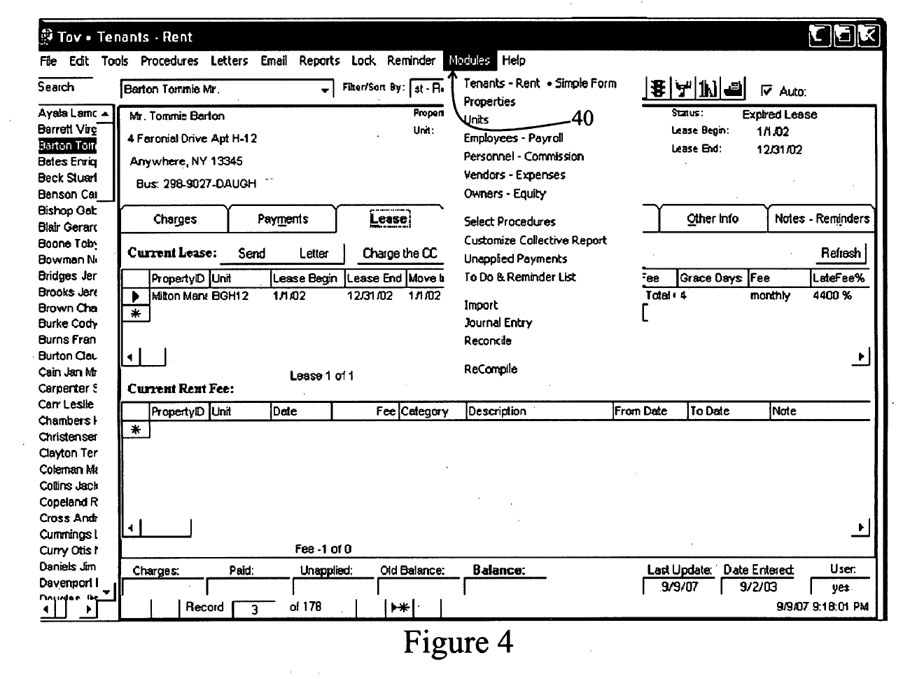

You can access any module by clicking on it from the Modules menu 40 in FIG. 4. All information is relational and provides ease and flexibility to the user running the program. Also, the user does not have to go through several screens in order to finally access the information he is looking for. All the information is displayed on one screen.

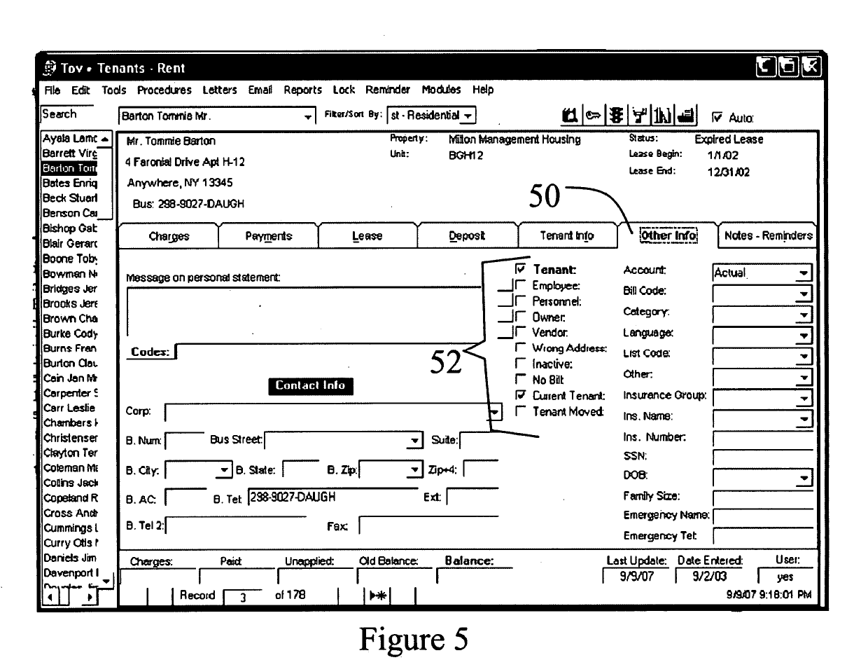

In FIG. 5 as in one embodiment occasionally, a tenant who resides in one of the properties may also be an employee, a member of your personnel team, an owner of one or more of your properties, and/or one of your vendors. To keep track of this information, the user can use the check-boxes 52 on a other info tab 50. This avoids the need to enter the same name several times into the database. Entering the name once is sufficient to be able to view all his information, and keep accessing his account and adding any pertinent information. To go to the selected tenant's record in another module, one can simply click the command buttons next to the check boxes. Most financial programs require the user, for each transaction entered, to specify the debit and credit account that it should be posted to. The present invention has a unique feature to enable you to do a one time setup chart of accounts 60.

Once you've created the chart of accounts 60, you then create a table of categories 70, assigning a debit and credit account for each category, by selecting from the Debit and Credit ID drop downs. A description, which explains the meaning of the category, can be added to each category. Upon recording a transaction in the charges tab 81, the user only has to choose a category 84, and the software will automatically post it to the proper debit and credit accounts, and will also enter the description automatically.

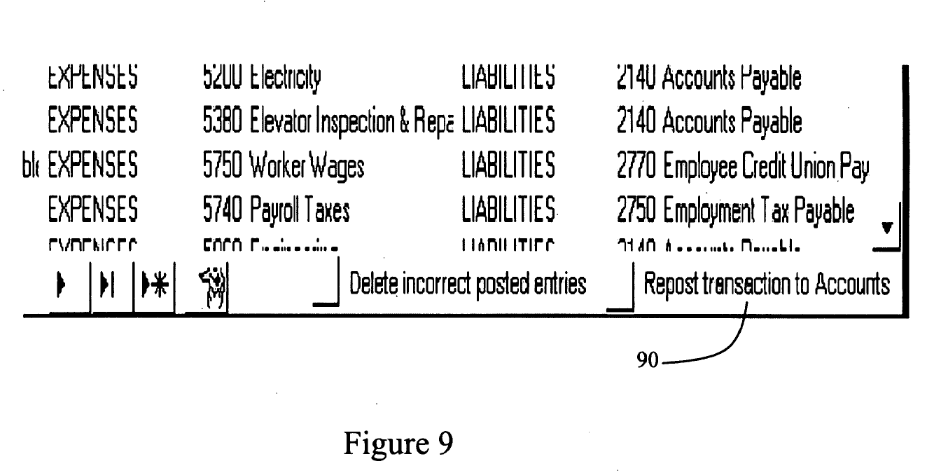

If during the initial setup, you assigned an incorrect debit and credit account to a specific category, you can go back to the setup screen, correct the error there. Once the error has been corrected, and a new DR or CR account has been assigned, the user then clicks on Repost transaction to Accounts 90 of FIG. 9, and the present invention will change all transactions incorrectly posted at once.

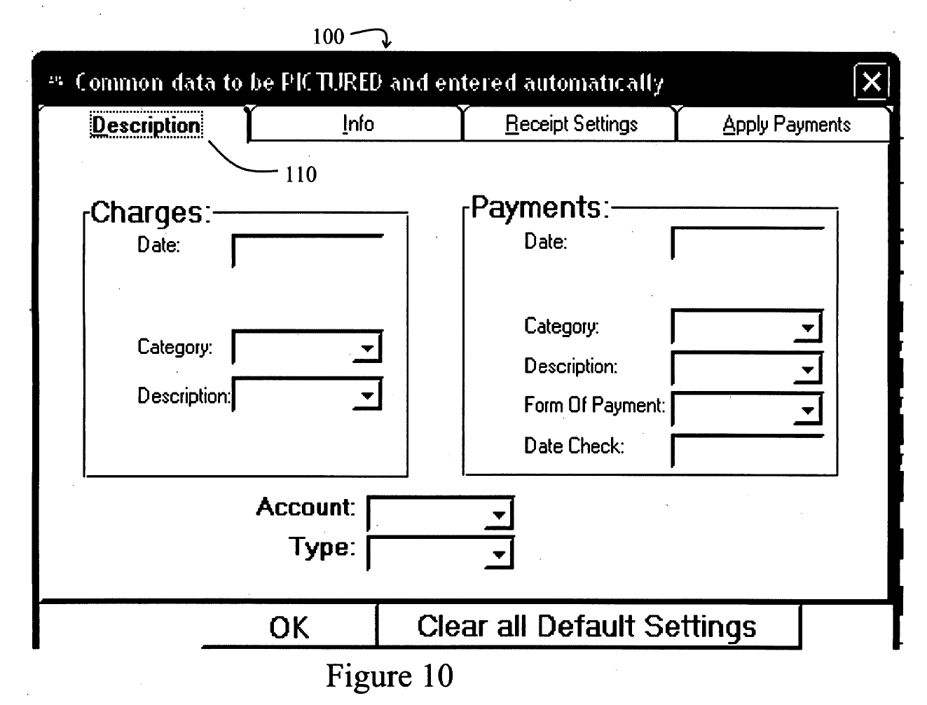

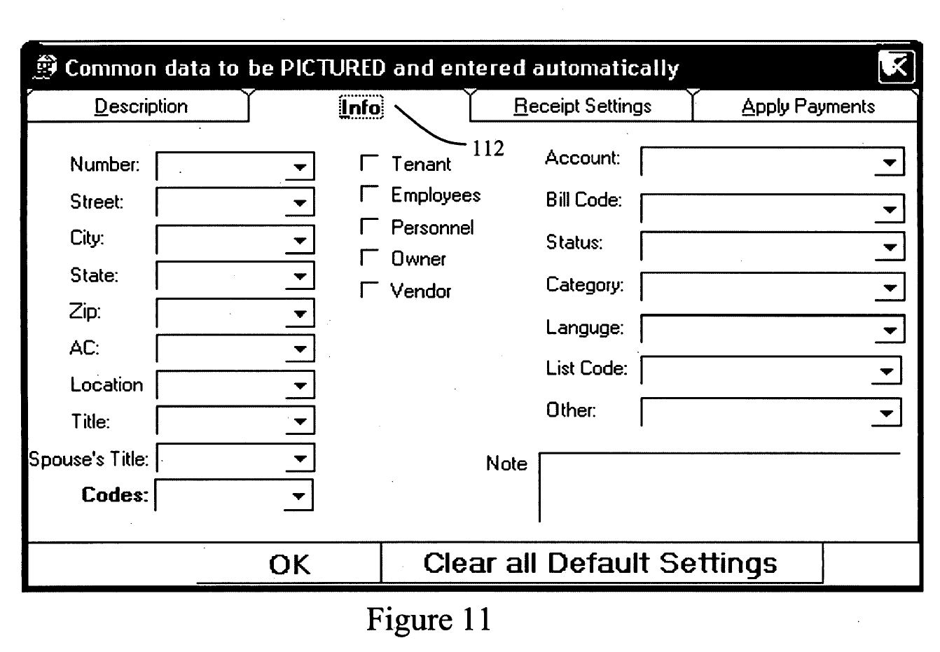

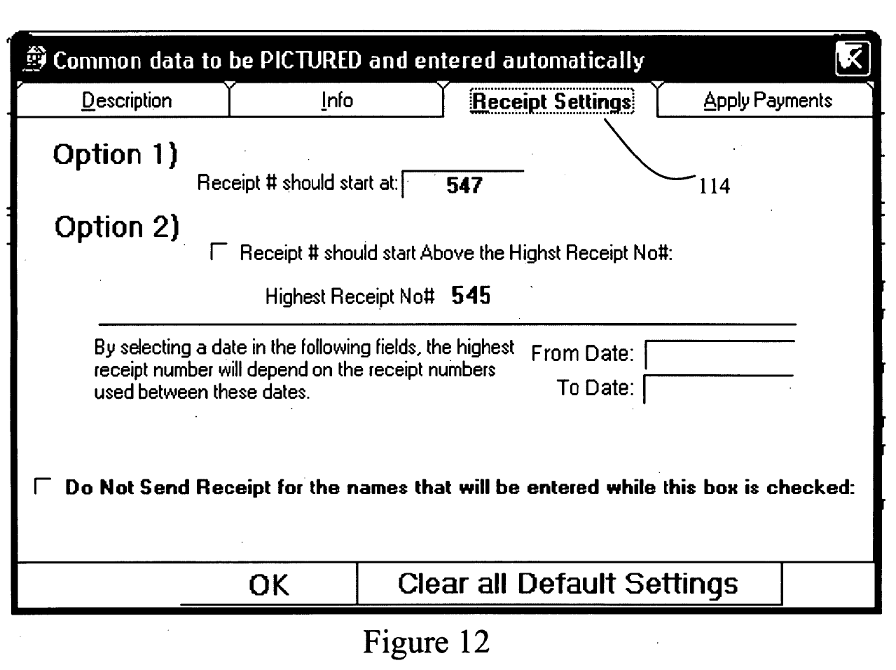

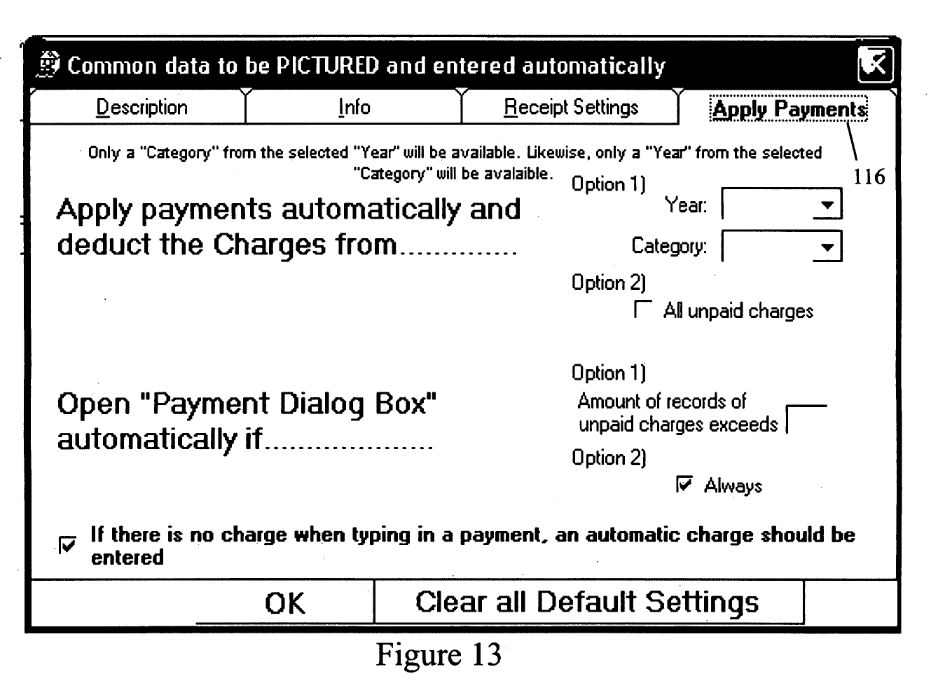

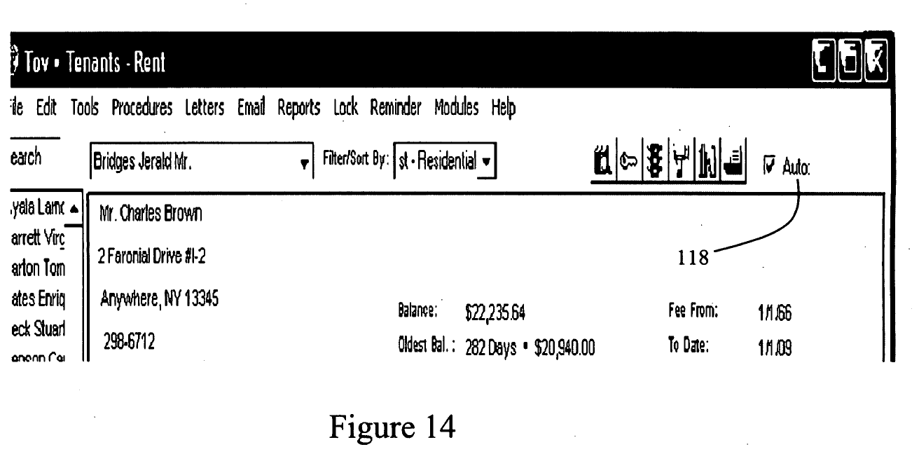

In FIGS. 10 to 14 are The Picture It tool that eliminates the need for retyping identical information into more than one record. In all modules throughout the program, this tool allows you to type data into a “clipboard,” from where the data can be automatically applied to more than one record.

For example, the “Picture It” feature comes in handy, when you have very many transactions of a similar nature, i.e. they all share the same date, category and description. You only need to enter the information once, and “Picture It” will fill in the data fields with the identical information. When you enter the amount of the transaction, the above mentioned information, for example the date, category and description, will flow into the record automatically.

To enter data that is relevant for more than one record click on the Picture It button. A dialog box labeled “Common data to be PICTURED and entered automatically” 100 will open.

In the Description tab 110 you will use the data fields to enter the information you would like to use consistently. When you want to enter a list of names, that share the same city, state and zip, use the data fields in the “Info” tab 112 to enter the recurring information. Then, when you enter the tenant's name, in a new record, the city, state, zip will automatically flow into the record. In the “Receipt Settings” tab 114, you can set which number the Receipts should begin with, and other Receipt settings. In the “Apply Payments” tab 116 you can specify how payments should be applied to its proper charges automatically.

To activate the picture it feature, place a checkmark in the box near Auto 118: in the top-right corner of the data entry form. The present invention will automatically apply the information you have entered in the “Picture It/Common data to be PICTURED and entered automatically” dialog box as soon as you begin entering any of that data.

Printing out Reports and creating Letters and Labels is also done in a most customizable fashion, allowing the user flexibility in selecting which records he wants displayed in the report or in the Letters and Labels. The Multi Selection and Exclusion options of displaying the records, allows the user to customize the Reports, Letters and Labels according to his needs.

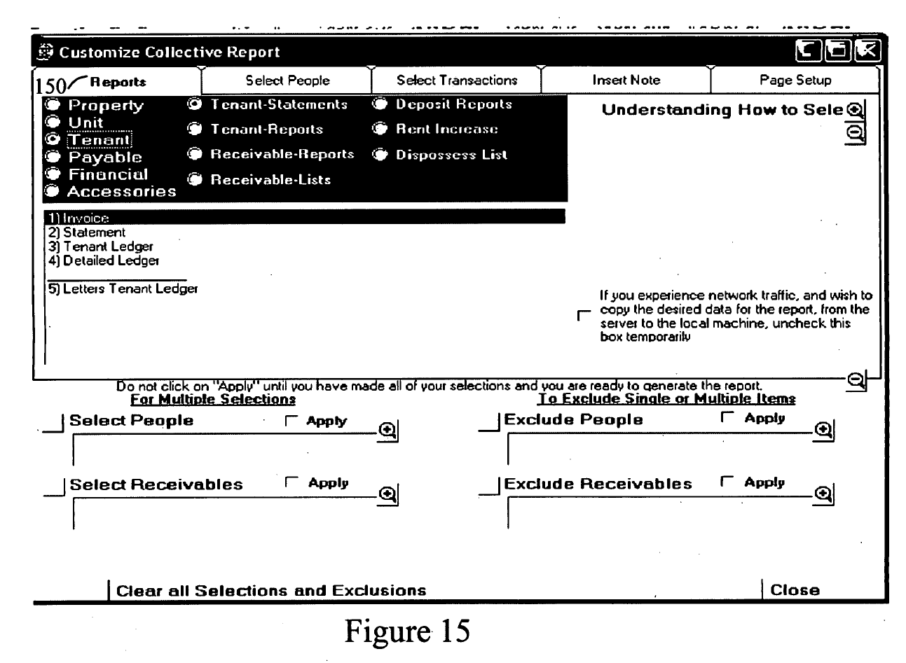

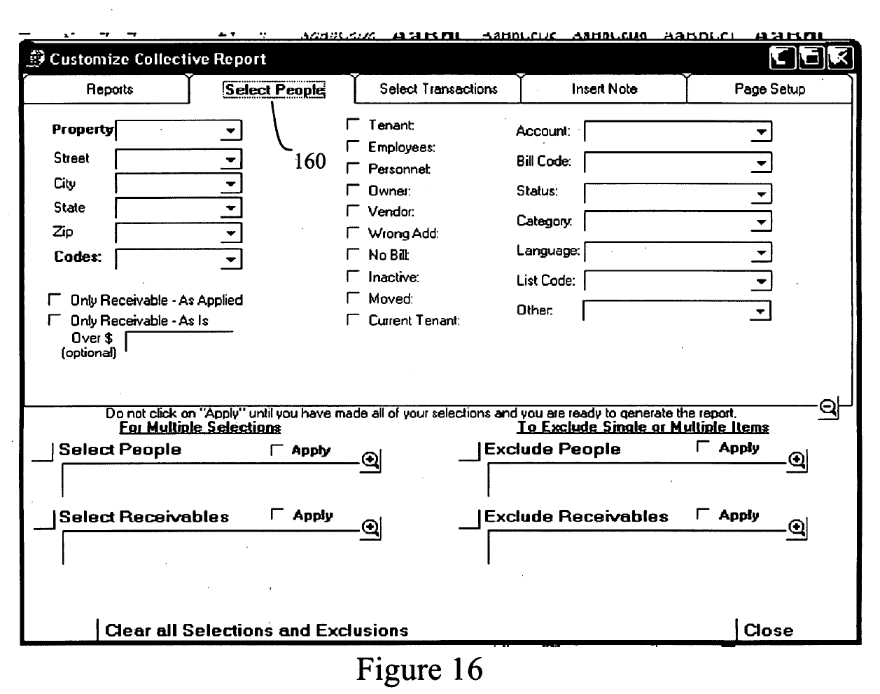

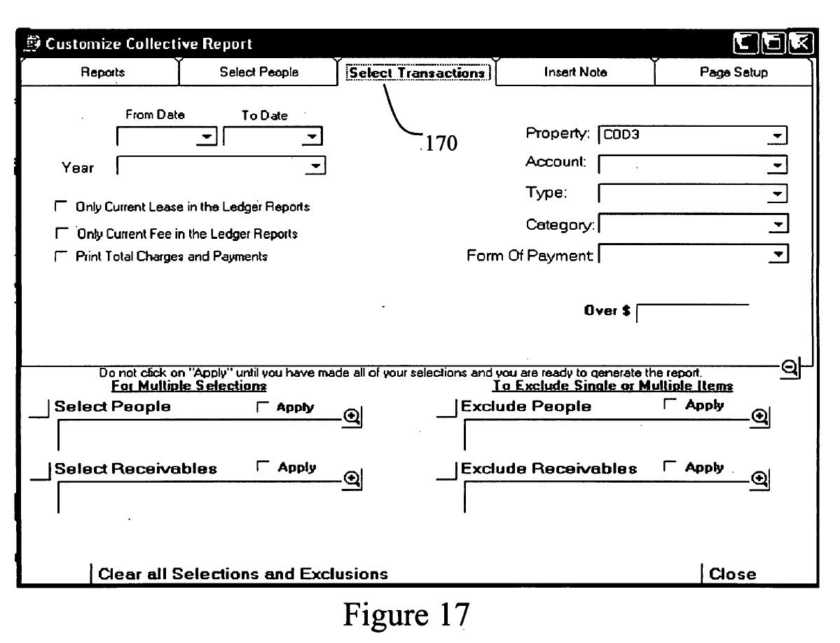

In FIGS. 15 to 17, to print Reports, click on Reports 150 in the menu bar, and choose Customize Collective Report. In the Customize Collective Reports dialog box, click on the Reports tab 150. The black shaded area to the left is a list of the main groups of Reports. Any selection you make from the black shaded list, will provide a list of selections in the blue shaded area to the right. This list names different groups of reports. Any item you select from this list, will change the list of available reports in the white area below, and will also provide a different selection of tabs, relevant to the selected report.

Click on the select people tab 160 and use the fields to select the information with which to filter the report. A select transaction tab 170 is shown. To include more than one selection from a given data field, use the appropriate Select button(s) under the “Multiple Selection” header, on the lower part of the dialog box, to record your selections. Select the appropriate records—one at a time—using the fields above; while clicking on the Select button between each selection. This unique selection method allows you to make multiple selections, without losing the previous selection(s).

The same applies to excluding single or multiple items from the report. To exclude one or more items from the report, select the item(s) you wish to exclude using the “Exclude” buttons(s) on the lower part of the dialog box.

To activate your selection(s) and/or exclusions, place a checkmark in the box marked Apply. To generate the desired report: Click on the Reports tab, and double-click on the name of the report you would like to generate. The present invention will open the report in a new window, where you can view, print, save and/or export the report to other applications.

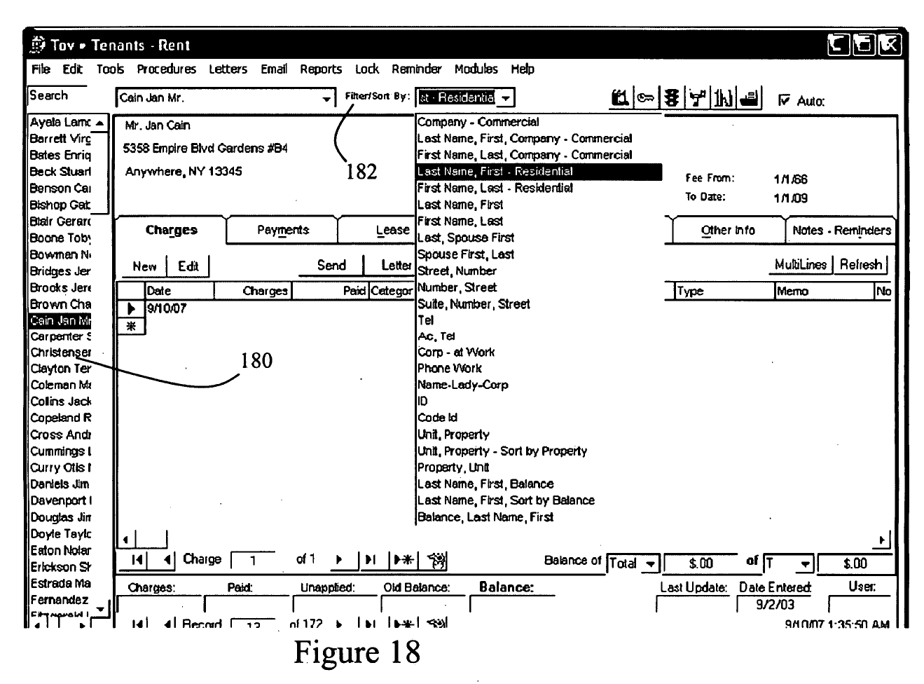

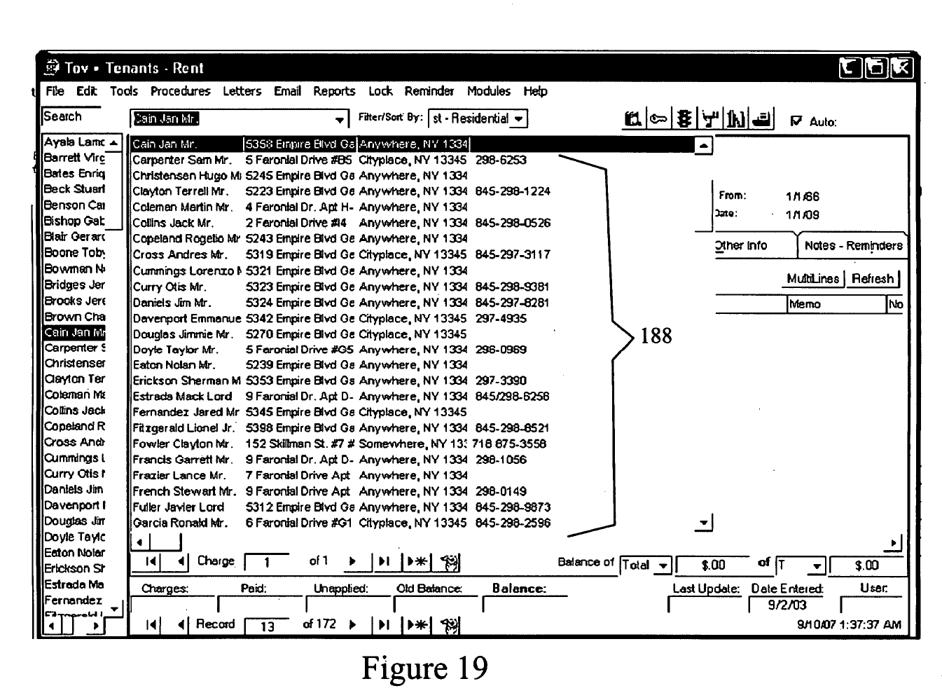

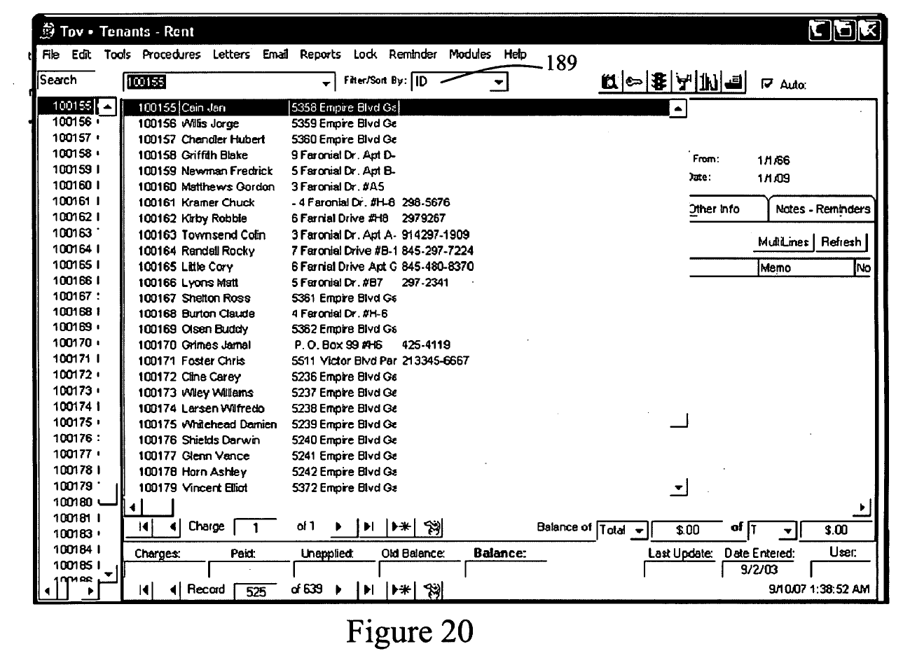

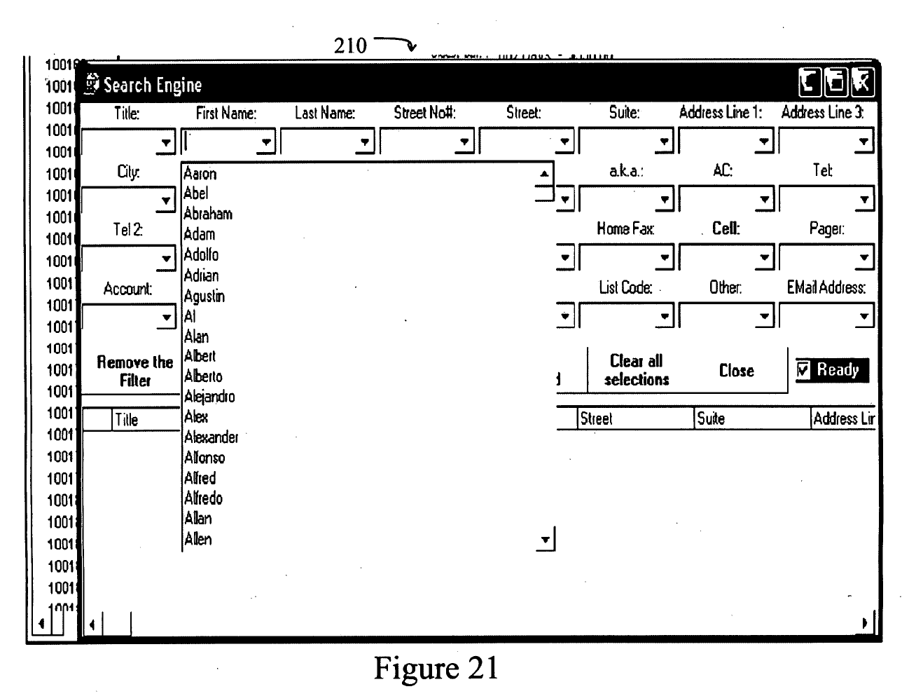

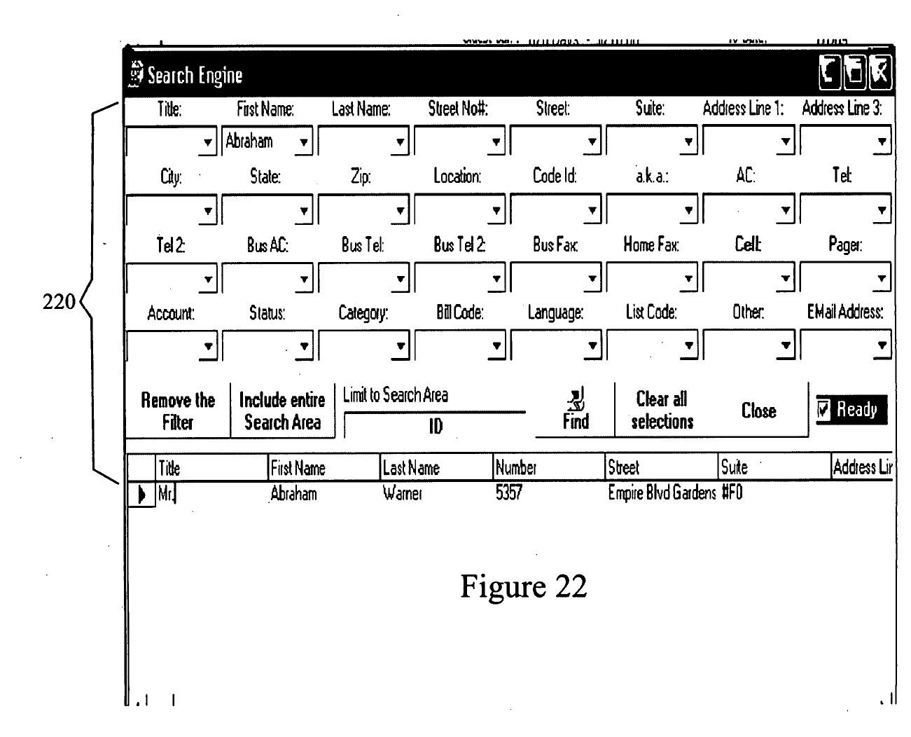

Referring to FIGS. 18 to 22. There are 3 methods to search a name, each one unique in its design and setup. Searching a name can be accomplished by selecting: 1) From a list shown on the screen displaying all the names. 2. From a Search dropdown list on the top of the screen, 3. From the Search engine, where you can customize your search, and narrow it down to specific details.

The first method is fairly simple. Clicking on any name in a name list 180 on the screen, will display the record with all its information. The second method, is by clicking on the Search drop down 188, displaying the list of names. One can set the way the search for data should be conducted.

To customize the Search tool using the Filter/Search 182 by feature (located to the right of the Search box): Click on the Filter/Search By drop-down triangle, and select the fields to sort the records by. For example: if you select “Last Name, First”; the tenant records 188 that will appear when you click the Search drop-down triangle will be sorted first by Last Name, then by First Name.

The ‘Filter/Search By’ feature also acts as a filter, listing only the records that include the field you have set the ‘Filter/Search By’. For example, if the ‘Filter/Search By’ is set to Last Name, First, only the records that include a Last Name will be displayed. Therefore, when adding a new Name, you must enter a Last Name, in order for it to show up in the list.

If you select ID 189 the records that will appear when you click the Search drop-down triangle, and the Search list on the left as well, will be sorted by ID, as in the diagram to the left. To search for a record using the Search Engine: Click on the Search Engine icon, which is the first one to the left among the other ‘Tools’ icons . Using the drop-down triangles in the Search Engine dialog box 210, select the data for which you wish to find all matching records. You may select data in as few or as many data fields as you wish. With each selection you make, the search area becomes limited to the selected criteria. Therefore, upon opening the next drop down in the Search Engine dialog box, you will only find those records that match the previously selected criteria. Click Find to display the matching records 220 to your selected criteria. Clicking on a record in the list of displayed results will open that particular record in its respective module.

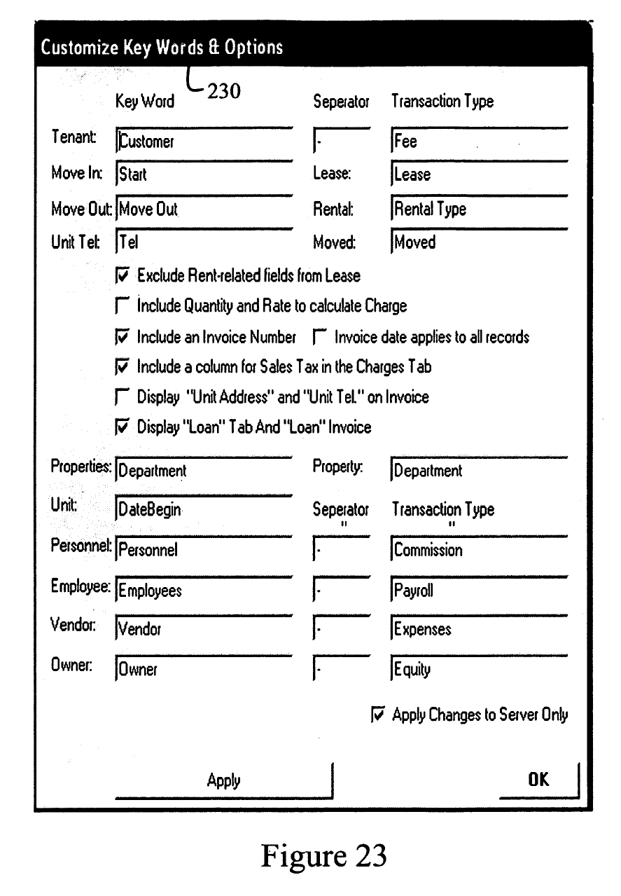

In FIG. 23 shown is a custom key words & options window 230. Shown are various features that can be customized into the software. To access the dialog box to customize the software, select from the File Menu on the Main Screen, “Customize Key Words and Options”. The dialog box will open, giving you several options to customize the software according to your business's needs. The flexibility of customizing the software serves a dual purpose. Firstly, one can customize the language of the individual user's computer to display the keywords in the software, in the language desired.

Secondly, the user can customize the software so that it can be used to conduct any type of business to track income and expense activity.

The Key Words can be changed in the fields provided, so that for example, a business not dealing with Tenants and rent management, can change the keyword “Tenant” to “Customer” and “Properties” to “Department” etc.

Other options for customization that can be specified in this dialog box are as follows: 1. One can Exclude Rent-related fields from Lease, so that the Lease can be used as a contract for any type of business. 2. Include Quantity and Rate in the Invoice to calculate Charges. 3. Include an Invoice Number on Invoice. 4. Specify if the Invoice date should apply to all records in the invoice, or select a different date per row. 5. Include a column for Sales Tax in the Charges Tab. 6. “Unit Address” and “Unit Tel.” on Invoice, gives you the option to use the address and telephone number, which can be renamed to accommodate the needs of the business. 7. Display “Loan” Tab And “Loan” Invoice, to keep track of any loans made by the business.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A method to manage property comprising:
providing a list of projects;
integrating the list of projects with a database;
creating a data display window to show data from the database; and
clicking on a property name in the data display window to open a selected tenant's record.

2. The method of claim 1 wherein the list of projects is seven individual projects that are tenants-rent, tenants rent-simple form, properties, units, personnel-commission, employees-payroll, vendors-expenses and owners-equity.

3. The method of claim 1 wherein check-boxes on an other info tab is used to keep track of a tenant who reside in one of the properties who are a selected one of an employee, a member of your personnel team, an owner of one or more of your properties, and one of your vendors, this avoids the need to enter the same name several times into the database.

4. The method of claim 1 wherein a units tab provides a list displaying all tenants occupying units, a user can click on any tenant's name and open a tenant's account in a tenant's module, displaying the tenant's pertinent information, there is no need to exit the section you currently are in to enter another section.

5. The method of claim 1 wherein a user can access any module by clicking on it from a modules menu, all information is relational and provides ease and flexibility to the user running the program, the user does not have to go through several screens in order to finally access the information he is looking for, all the information is displayed on one screen.

6. The method of claim 1 wherein creating a chart of accounts and a table of categories, assigning a debit and credit account for each category by selecting from a debit and credit ID drop downs, a description which explains the meaning of the category is be added to each category, upon recording a transaction in the charges tab, the user only has to choose a category and the software will automatically post it to the proper debit and credit accounts, and will also enter the description automatically.

7. The method of claim 1 wherein a picture it tool eliminates the need for retyping identical information into more than one record, in all modules throughout the program, this tool allows you to type data into a clipboard from where the data can be automatically applied to more than one record.

8. The method of claim 1 wherein printing reports by clicking on reports in the menu bar and choosing customize collective report.

9. The method of claim 1 wherein searching a name by selecting from a list shown on a screen displaying all the names.

10. The method of claim 1 wherein searching a name from a search dropdown list on a top of the screen.

11. The method of claim 1 wherein searching a name from a search engine, where you can customize your search, and narrow it down to specific details.

12. The method of claim 1 wherein customizing the software using a customize key words and options, a dialog box will open giving you several options to customize the software according to your business's need, the user can customize the language of the individual user's computer to display the keywords in the software and in the language desired.
